(19) United States
(12) Patent Application Publication
(10) Pub. No.: US 2002/0005126 A1
(43) Pub. Date: Jan. 17, 2002

(54) Method for dyeing both surfaces of cloth

(76) Inventor: Noriko Asami, Tokyo (JP)

Correspondence Address: HOLLAND & KNIGHT LLP, Suite 800, 55 W. Monroe Street, Chicago, IL, 60603, US

(21) Appl. No.: 09/946,640

(22) Filed: Sep. 4, 2001

(30) Foreign Application Priority Data
Feb. 18, 1999 (JP) H11-39695

(51) Int. Cl. B41M 1/12

(52) U.S. Cl. 101/129

(57) ABSTRACT

A method for dyeing both surfaces by different colors and/or patterns by means of screen imprinting is provided. The method comprises adding, to a color paste prepared from sodium alginate and a reactive dye or a disperse dye, a surfactant in an amount of 0.5 to 30% by weight of the color paste. □

### BACKGROUND OF THE INVENTION

1. Field of the Invention

The present invention relates to a method for dyeing both surfaces of cloth. More specifically, the invention relates to a method for dyeing both surfaces of cloth in different colors and/or patterns.

2. Description of the Prior Art

Hitherto, fine patterns were dyed on both surfaces of cloth. In this method, colorless paste was put on both surfaces of cloth and then each surface was dyed. Starch was used as the paste and a direct dye or an acid dye was used for dyeing in view of processability and economical reasons. However, both surfaces-dyeing of cloth has not been effected in an industrial scale.

Conventional both surface-dyeing methods had the following defects:

(a) Direct dyes are not durable against washing, heat and light, and are liable to discolor. Few direct dyes have vivid colors.

(b) If a reactive dye which can hold colors at a higher temperature and is durable against detergents is used in place of a direct dye, starch pastes discolor. Thus a reactive dye cannot be used for silk.

(c) Starch pastes are apt to cause public pollution.

### SUMMARY OF THE INVENTION

An object of the invention is to eliminate the above-mentioned defects of the conventional both surfaces-dyeing methods and provide a method for dyeing both surfaces of a piece of cloth in an industrial scale.

According to the present invention, there is provided a method for dyeing both surfaces of cloth by means of screen imprinting using a color paste, which comprises adding, to a color paste prepared by using as an initial paste sodium alginate and as a dye a reactive dye or a disperse dye, a surifactant in an amount of 0.5 to 30% by weight of the color paste.

### DETAILED DESCRIPTION OF THE PREFERRED

### EMBODIMENT

The dye used for preparing the color paste is a reactive dye or a disperse dye, preferably a reactive dye, when the cloth to be dyed is made of natural fiber such as cotton cloth, hemp cloth, etc. On the other hand, when the cloth to be dyed is made of chemical fiber such as polyester, preferably a disperse dye is used.

The method of the invention typically includes the following steps:

(a) preparing an initial paste by adding to water sodium alginate and optionally carboxymethyl cellulose(CMC);

(b) preparing a color paste by adding to the initial paste a reactive dye or disperse dye and a reducing agent;

(c) adding to the color paste a surfactant in an amount of about 0.5 to about 30% by weight of the color paste;

(d) placing a piece of cloth on a hot plate;

(e) placing a silk screen having a pattern on one surface(first surface) of the cloth on the hot plate, and then placing and brushing the color paste on the silk screen; and thereafter, similarly subjecting the other surface of the cloth using the same or different color paste and using a silk screen having the same or different pattern, thereby dyeing the both surfaces of the cloth with different colors and/or in different patterns;

(f) steam treating the dyed cloth to fix or adhere the dye(s) on the cloth;

(g) washing away the color paste(s) from the cloth; and

(h) drying the dyed cloth.

Specifically, each of steps (a) through (h) can be effected as follows:

Step (a)

The initial paste (usually having a viscosity in the range of from about 50,000 to 200,000 cps) can be prepared by adding to 1 liter of water 30 to 70 g, typically about 50 g, of sodium alginate of which 1% aqueous solution has a viscosity in the range of from about 200 to 1,300 cps, particularly 500 to 1,000 cps [e.g. a sodium alginate product sold under the tradename NEWTEX F-SH (manufactured by Fuji Kagaku Kogyo Co., Ltd., Japan) having a viscosity of 700 cps]. Optionally, carboxymethyl cellulose (CMC) may be added thereto in an amount of about 15 to 30% by weight of the sodium alginate to increase the viscosity of the paste.

Step (b)

To 500 ml of the initial paste, a reactive dye or disperse dye and a reducing agent are added each in an amount conventionally used, and water is also added to give 1 liter of a color paste having a viscosity of about 10,000 cps. In the case where a higher viscosity is desired, the amount of the initial paste is increased. If the viscosity of the color paste is high, the color paste does not sufficiently penetrate into the cloth and does not exude through the cloth to the opposite surface. However, in order to brush the color paste on a screen, it must have a certain degree of flowability. As the reactive dye, any of low-temperature type, medium-temperature type and high-temperature type dyes can be used.

Step (c)

Examples of the surfactant to be added to the color paste are preferably anionic surfactants. For example, an anionic surfactant FUJIRON PS (trademark, manufactured by Fuji Kagaku Kogyo Co., Ltd., Japan) can be used. The amount of the surfactant is tusually about 0.5 to about 30% by weight, preferably about 0.5 to about 10% by weight, particularly about 0.5 to about 1.5% by weight of the color paste. By the addition of the surfactant, the color paste can be prevented from exuding to the opposite surface of the cloth and can be readily brushed on a silk screen.

Step (d)

The hot plate is maintained usually at 40 to 50° C. By heating the cloth, penetration of the color paste into the cloth is decreased and thus exudation of the color paste to the opposite surface of the cloth can be prevented.

Step (f)

After dyeing, the cloth is steam-treated at about 170 to about 230° C., preferably at about 190 to about 210° C., for about 5 to 20 minutes, preferably for around 10 minutes, e.g. about 8 minutes, whereby the dye is adhered to the cloth.

According to the present invention, there can be obtained the following effects and advantages:

(i) Since sodium alginate is used as an initial paste, discoloration as seen in the case where starch is used does not occur, and desizing can be readily effected. When a reactive dye is used, the cloth, particularly natural fiber cloth, can be dyed with vivid colors and the resulting dyed cloth exhibits excellent fastness to crocking, sunlight and washing.

(ii) Color and pattern on one surface of the cloth is prevented from exuding to the opposite surface, whereby formation of different colors and/or different patterns on the both surfaces of cloth is enabled.

(iii) Brushing during dyeing procedure can be smoothly effected.

What is claimed is:

1. A method for dyeing both surfaces of cloth by means of screen imprinting using a color paste, which comprises adding, to the color paste prepared by using sodium alginate and a reactive dye or a disperse dye, a surfactant in an amount of 0.5 to 30% by weight of the color paste.

2. The method according to claim 1, wherein the surfactant is selected from anionic surfactant and non-ionic surfactants.

3. The method according to claim 1, wherein the surfactant is added in an amount of 0.5 to 1.5% by weight of the color paste.

4. The method according to claim 1, wherein the cloth is natural fiber cloth and the dye is a reactive dye.

5. The method according to claim 2, wherein the surfactant is an anionic surfactant.
